(19) United States
(12) Patent Application Publication
(10) Pub. No.: US 2006/0043094 A1
(43) Pub. Date: Mar. 2, 2006

(54) Modular machine for storage or transportation of compressed gas cylinders

(76) Inventor: Sean Stavros Farley, Woodland Hills, CA (US)

Correspondence Address: Sean Stavros Farley, 4450 Shopping Lane, Simi Valley, CA, 93063, US

(21) Appl. No.: 10/933,641

(22) Filed: Sep. 2, 2004

(51) Int. Cl. F17C 1/00

(52) U.S. Cl. 220/581

(57) ABSTRACT

A modular machine for storage or transportation of compressed gas cylinders. with multiple Modules(10); Posts(12); Bushings(11); Post Connectors(13); Casters(14); Leveling Feet(15)

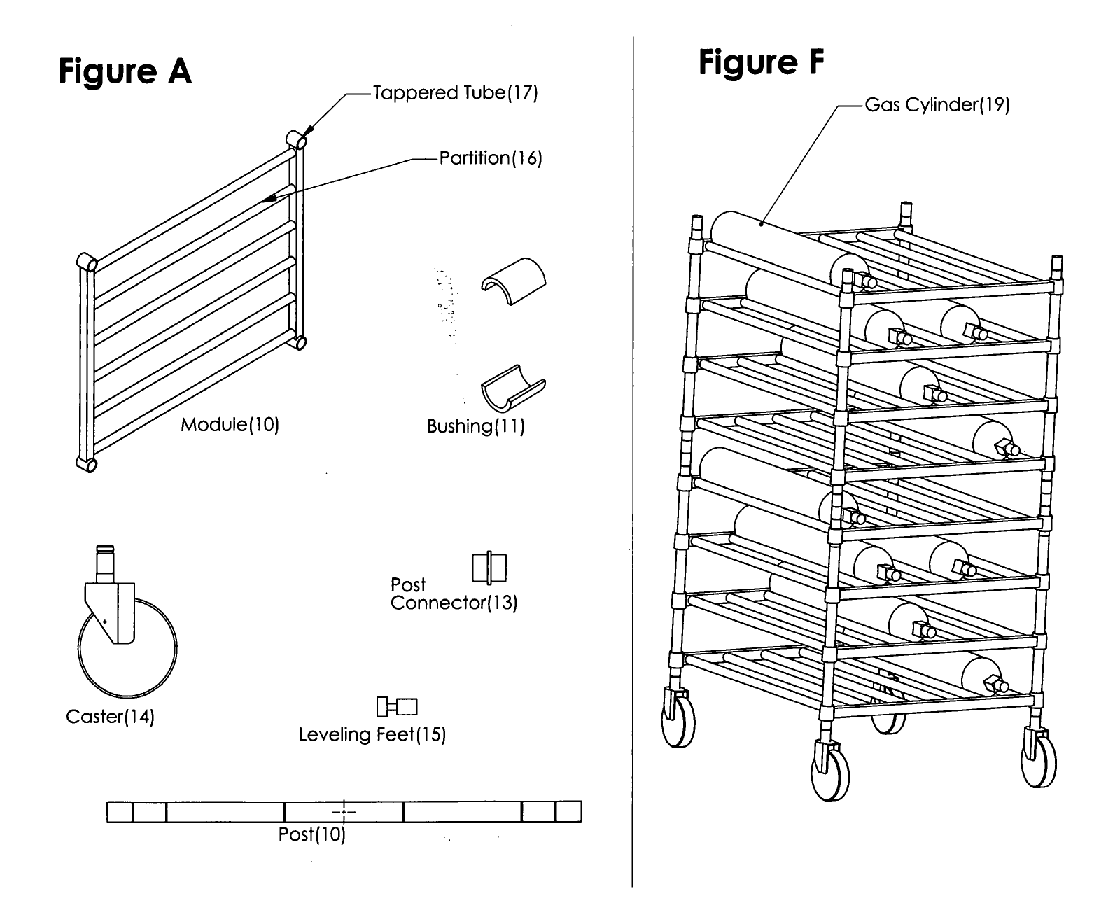

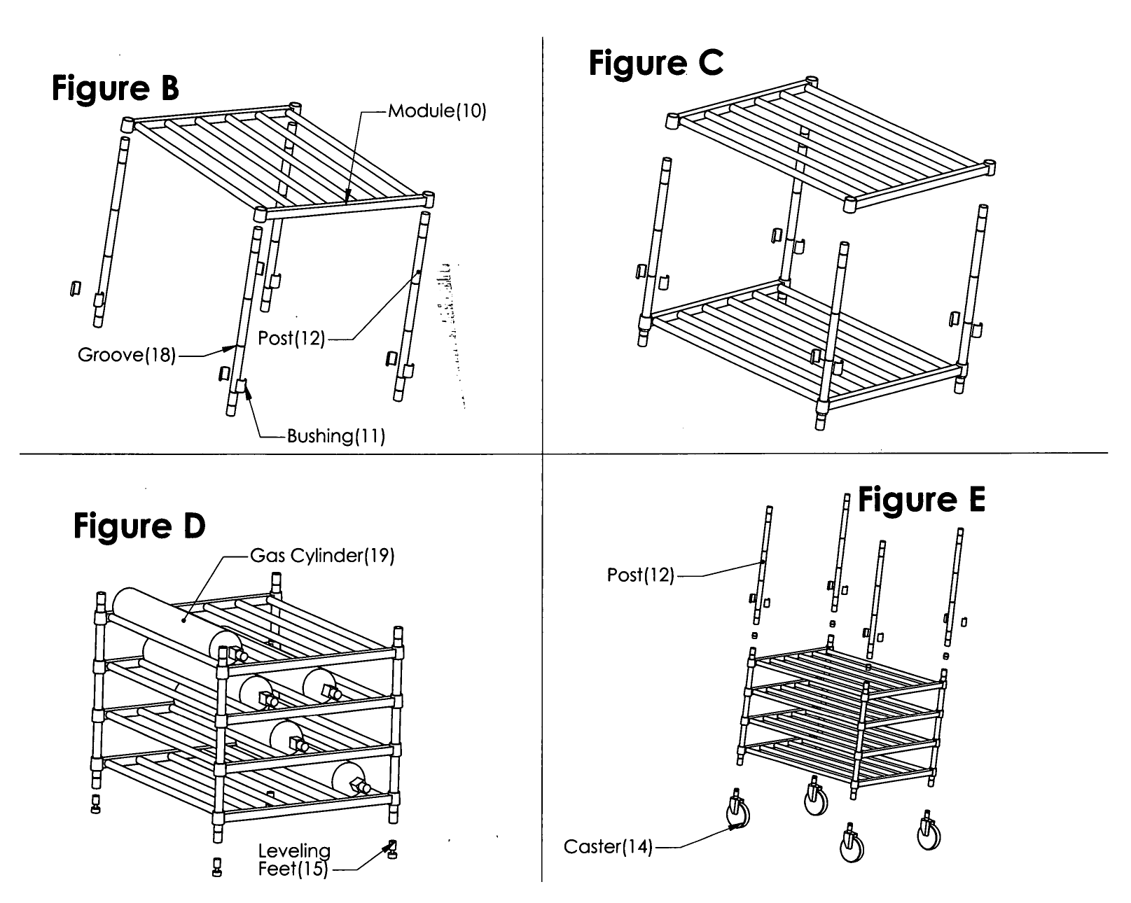

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of transportation and storage and more specifically to a modular machine for storage or transportation of compressed gas cylinders.

The storage and transportation of compressed gas cylinders has been around since the compressed gas cylinder. Safety regulations and guidlines required by OSHA and DOT place certain guidlines to the storage and transportation of compressed gas cylinders due to the high pressure and the danger associated with this high pressure. Cylinder carts and racks have been designed and manufactured by various companies for years. They are comprised of all welded steel construction.

The shortcomings of previous technology is that the units are one piece all welded construction. Shipping and storage of these units is very costly. Manufacturing of these units are very expensive to manufacture.

### BRIEF SUMMARY OF THE INVENTION

The primary object of the invention is to stack gas cylinders horizontal to the floor. Which allows multiple layers of cylinders to be stacked verticaly, thus allowing a greater amount of cylinders to be stored in a small footprint.

Another object of the invention is cylinders are positively placed, meaning cylinders do not move around once stored, thus creating a silent rack/cart system.

Another object of the invention is unit is versatile. Unit can have casters to make a cart or leveling feet to create a stand.

A further object of the invention is a modular design that Will help reduce the costs associated in shipping.

Yet another object of the invention is modular units are less expensive to manufacture.

Still yet another object of the invention is modular units are less expensive to ship since units are shipped knocked down.

Another object of the invention is unit is easily assembled.

Another object of the invention is unit is made up of strong lightweight steel construction.

A further object of the invention is unit assembles with the use of a mallet or hammer. No other tools are needed to assemble.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a modular machine for storage or transportation of compressed gas cylinders. comprising: multiple Modules(10), side Posts(12), Bushings(11) 4 sets per module, Post Connectors(13), 4 Casters(14) for cart version, 4 Leveling Feet(15) for stand version.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

Figure A is an exploded view which shows all components of the unit.

Figure B is a perspective view of the invention which shows the first step of assembling the unit. The Module(10) is attached to the Post(12) by snapping the Bushing(11) around the Grooves(18) on the Post(12) and then sliding the Module(10) over the Post(12) and the Bushing(11), creating a friction lock between the Module(10), Bushing(11) and the Post(12).

Figure C is a perspective view which shows a Module(10) securely attached to the 4 individual Posts(12), As well as an additional Module(10) being attached to the 4 Posts(12) with additional Bushings(11).

Figure D is a perspective view which shows 4 Modules(10) assembled to 4 Posts(12), with 5 Gas Cylinders(19) stored in between each Partition(20).

Figure E is a perspective view which shows Casters(14) being added to the assembly as well as 4 additional Posts(12). Posts(12) can be attached together with the use of Post Connectors(13). Additional modules may then be added.

Figure F is a perspective view of the complete assembly cart version.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

A modular machine for the storage or transportation of compressed gas cylinders. Unit is made up of modular components comprising of Modules(10); Posts(12); Bushings(11); Post Connectors(13); Casters(14); Leveling Feet(15)

The cart & racking system is a modular design that will help reduce the costs associated in shipping, manufacturing and the storage of the unit. When unit is assembled compressed gas cylinders are stored in a horizontal fashion. Each cylinder is positively placed in the Modules(10). Depending on the requirements each Module(10) can store between 2 cylinders up to 10 cylinders side by side. This is done by widening the Module(10) and adding additional Partitions(16).

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A modular machine for the storage of compressed gas cylinders comprising:
Modules(10);
Bushings(11);
Posts(12);
Post Connectors(13);
Casters(14);
Leveling Feet(15)
